(19) United States
(12) Patent Application Publication
(10) Pub. No.: US 2008/0030492 A1
(43) Pub. Date: Feb. 7, 2008

(54) DISPLAY APPARATUS FOR IMPROVED OPTICAL COMMUNICATION

(76) Inventor: Ki-Chan LEE, Cheonan-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/776,101

(22) Filed: Jul. 11, 2007

(30) Foreign Application Priority Data
Aug. 1, 2006 (KR) 2006-72599

(51) Int. Cl. G06F 3/038; H04B 10/06

(52) U.S. Cl. 345/207; 398/202

(57) ABSTRACT

A display apparatus for optical communication that has increased sensitivity to optical signals is presented. The display apparatus has a display panel displaying an image. The display panel has a light receiver that is formed in the display panel to receive an optical signal and output a photo-current corresponding to the received optical signal. A controller decodes the photo-current from the light receiver to obtain the data that was encoded in the optical signal. The color filter layer in the display panel is made thinner than in a conventional display panel, and the light receiver receives the optical signals through the color filter layer. As a result, transmission of the optical signals to the light receiver is increased and a receiving sensitivity of the light receiver is improved.

### CROSS-REFERENCE TO RELATED APPLICATION

This application relies for priority upon Korean Patent Application No. 2006-72599 filed on Aug. 1, 2006, the content of which is herein incorporated by reference in its entirety.

### BACKGROUND OF THE INVENTION

1. Field of the Invention

The present invention relates to a display apparatus for optical communication. More particularly, the present invention relates to a display apparatus capable of improving receiving sensitivity.

2. Description of the Related Art

Recently, due to the popularization of portable communication apparatuses, communication systems utilizing either an electric wave or an infrared communication scheme are becoming more ubiquitous. However, available frequencies are currently being exhausted, and infrared communication schemees utilizing an infrared wavelength that is harmful to human body have been restricted in usage. Therefore, in recent years, a communication scheme utilizing lights has been developed for safe communication.

In addition, white light emitting diode has been developed recently. The white light emitting diode has the advantages of low electric power consumption, compactness and long durability in comparison with an incandescent electric light or a fluorescent light. Therefore, research and development of turning the light emitting diode on-off or adjusting the quantity of light are actively being performed to provide the light emitting diodes with a signal transmission function.

Meanwhile, a portable terminal is generally provided with a light receiver, such as a photodiode, as a light sensor to receive the light from the light emitting diode. However, if the portable terminal is equipped with the photodiode, the cost of products rises due to an additional part, such as the photodiode, and manufacturing time increases. In addition, as the size of the portable terminal has become reduced, the photodiode is not easily installed in the portable terminal.

Further, since the number of photodiodes provided in the portable terminal is limited, sensitivity and light receiving rate of the light receiver is lowered, resulting in difficulty in increasing a response speed of optical communication.

### SUMMARY OF THE INVENTION

The present invention provides a display apparatus for optical communication capable of improving light sensitivity to achieve a faster response speed.

In one aspect, the present invention is a display apparatus for optical communication that includes a display panel, a light receiver, and a controller. The display panel displays an image. The light receiver is installed in the display panel to receive an optical signal and output a photo-current corresponding to the received optical signal. The controller decodes the photo-current output from the light receiver to obtain data encoded in the optical signal.

In the display apparatus for optical communication, a light receiver receiving the light with amorphous silicon is embedded in the display panel, so that a receiving sensitivity of the display apparatus for optical communication can be enhanced and the response speed can be increased.

### BRIEF DESCRIPTION OF THE DRAWINGS

The above and other advantages of the present invention will become readily apparent by reference to the following detailed description when considered in conjunction with the accompanying drawings, wherein:

FIG. 1 is a view illustrating an optical communication apparatus according to an exemplary embodiment of the present invention;

FIG. 2 is a plan view illustrating a display apparatus for optical communication shown in FIG. 1;

FIG. 3 is a sectional view illustrating a display panel for optical communication shown in FIG. 2;

FIG. 4 is a plan view illustrating a first light receiving sensor shown in FIG. 3;

FIG. 5 is a waveforms diagram showing a response speed of a second light receiving sensor as a function of a second electrical power;

FIG. 6 is a sectional view illustrating a display panel for optical communication according to another embodiment of the present invention;

FIG. 7A is a plane view illustrating a color filter layer shown in FIG. 6;

FIG. 7B is a plan view illustrating a color filter layer according to another embodiment of the present invention;

FIGS. 8A to 8D are sectional views illustrating a fabrication procedure for the color filter layer shown in FIG. 6 through a wet etching process; and

FIGS. 9A to 9D are sectional views illustrating a fabrication procedure for the color filter layer shown in FIG. 6 through a dry etching process.

### DESCRIPTION OF THE EMBODIMENTS

Hereinafter, the exemplary embodiment of the present invention will be explained in detail with reference to the accompanying drawings.

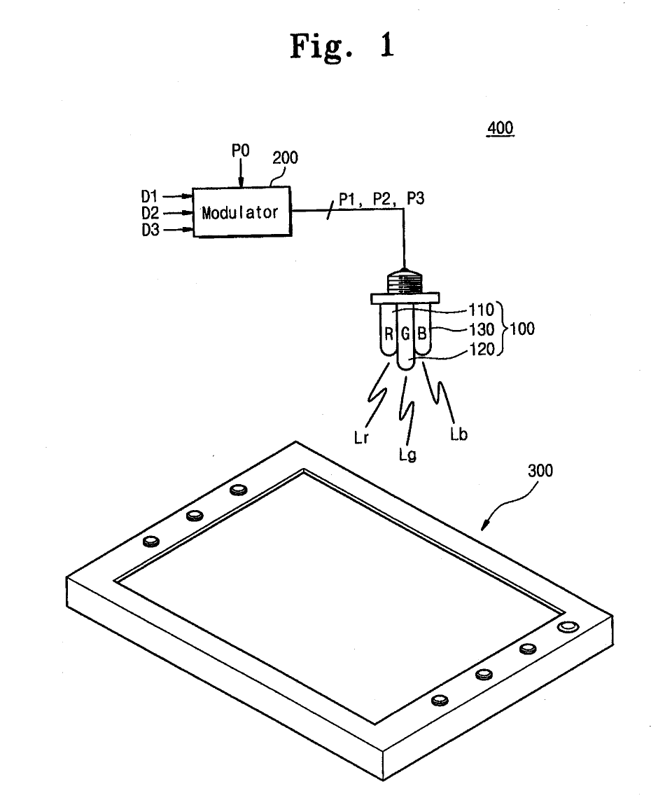

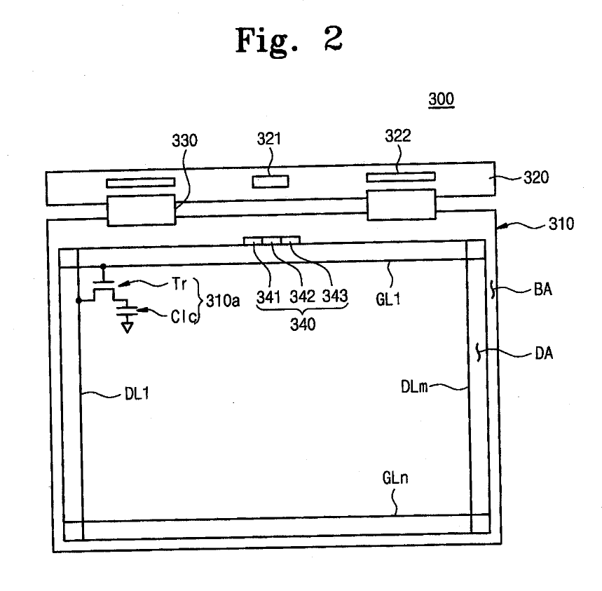

FIG. 1 shows an optical communication apparatus according to an exemplary embodiment of the present invention, and FIG. 2 shows a display apparatus for optical communication shown in FIG. 1.

Referring to FIGS. 1 and 2, an optical communication apparatus 400 includes a light generator 100 generating light, a modulator 200 controlling the light generator 100 and modulating the light, and a display apparatus 300 receiving a variety of data from the modulated light for optical communication.

The light generator 100 is used for indoor or outdoor illuminations, and includes a red light emitting diode 110 emitting a red light Lr, a green light emitting diode 120 emitting a green light Lg, and a blue light emitting diode 130 emitting a blue light Lb. In the present embodiment, the light generator 100 emits white light by using the red light Lr, the green light Lg, and the blue light Lb, so that the light generator 100 serves as a transmitter to perform optical communication while being used as an illuminator.

The modulator 200 receives an external electric power P0 and data to be transmitted and modulates the electric power to control the operation of the light generator 100 based on the data to be transmitted. For example, the modulator 200 may receive first, second and third data D1, D2 and D3, and modulate first, second and third electric power P1, P2 and P3 supplied to the red, green, and blue light emitting diodes 110, 120 and 130, respectively, based on the first to third data D1, D2 and D3. The first to third data D1, D2 and D3 may include characters, graphics, and sound data, respectively.

The modulator 200 modulates the light using On-Off Keying (OOK) scheme such that data information to be transferred can be carried on the light.

When the red light emitting diode 110 turns on and off in response to the first electric power P1, the red light Lr output from the red light emitting diode 110 is modulated to convey the information of the first data D1. Similarly, when the green light emitting diode 120 turns on and off in response to the second electric power P2, the green light Lg output from the green light emitting diode 120 is modulated to convey the information of the second data D2. When the blue light emitting diode 130 turns on and off in response to the third electric power P3, the blue light Lb output from the blue light emitting diode 130 is modulated to convey the information of the third data D3. The modulated red light Lr, green light Lg, and blue light Lb that are encoded with the first to third data D1, D2, D3 are herein generally referred to as “optical signals.”

Here, the flickering of the red, green, and blue light emitting diodes 110, 120 and 130 is accomplished rapidly enough to be undetectable to the naked eye, so that the red, green, and blue light emitting diodes 110, 120 and 130 look like they are continuously emitting light. Further, the red, green, and blue light emitting diodes 110, 120 and 130 may be independently driven, and wavelengths of the red light Lr, the green light Lg and the blue light Lb output from the red, green and blue light emitting diodes 110, 120 and 130 are distinguished from each other. Therefore, the light generator 100 can substantially simultaneously transmit the first to third data D1, D2 and D3 with the red light Lr, the green light Lg and blue light Lb.

As shown in FIG. 2, the display apparatus 300 for optical communication includes a display panel 310 displaying an image, a printed circuit board 320 controlling the operation of the display panel 310, and a flexible film 330 electrically connecting the display panel 310 with the printed circuit board 320.

The display panel 310 includes a display area DA that allows the light to pass therethrough to display an image, and a light blocking area BA, which is adjacent to the display area DA and blocks the light to prevent an image from being displayed. The display panel 310 corresponding to the display area DA is provided with a plurality of gate lines GL1 to GLn and a plurality of data lines DL1 to DLm. The gate lines GL1 to GLn and the data lines DL1 to DLm extend perpendicularly to each other while being insulated from each other and define a plurality of pixel areas on the display area DA. The pixel areas are arranged in a matrix configuration and provided with a plurality of pixels 310a.

Each pixel 310a includes a thin film transistor Tr and a liquid crystal capacitor Clc. In the present embodiment, the thin film transistor Tr of a first pixel includes a gate electrode connected to a first gate line GL1, a source electrode connected to a first data line DL1, and a drain electrode connected to the liquid crystal capacitor Clc.

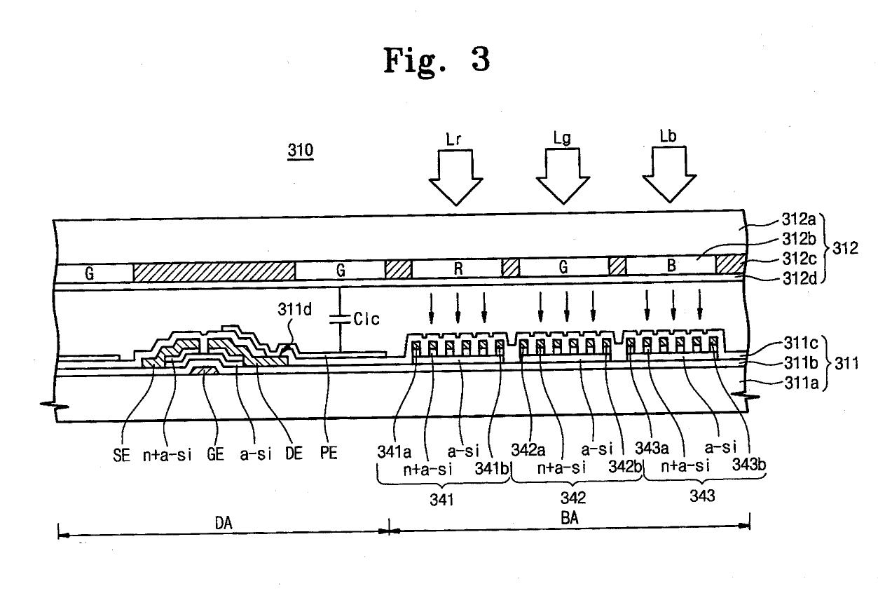

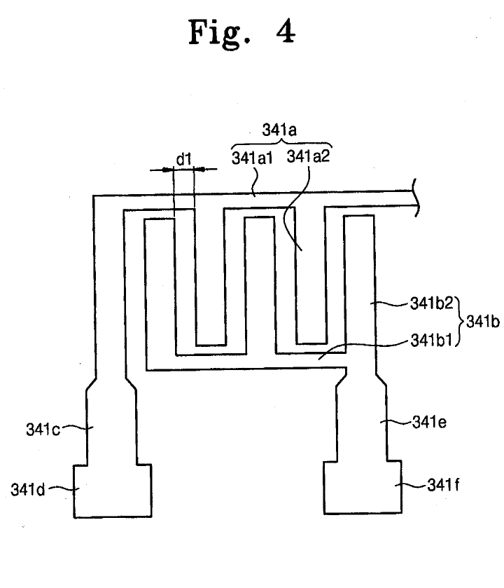

Meanwhile, a light receiver 340, which receives the red light Lr, the green light Lg and the blue light Lb from the light generator 100 shown in FIG. 1, is embedded in the light blocking area BA of the display panel 310. The light receiver 340 includes a first light receiving sensor 341 detecting the red light Lr, a second light receiving sensor 342 detecting the green light Lg, and a third light receiving sensor 343 detecting the blue light Lb. Hereinafter, the first to third light receiving sensors 341, 342 and 343 will be explained in more detail with reference to FIG. 3 and FIG. 4.

A controller 321 and a drive chip 322 are mounted on the printed circuit board 320. The controller 321 receives a variety of control signals and image data signals from an exterior and outputs a data control signal, a gate control signal and an image data signal. In the present embodiment, the drive chip 322 may have a data drive circuit (not shown) and a gate drive circuit (not shown). The data drive circuit converts the image data signal into a pixel voltage and outputs the pixel voltage in response to the data control signal, and the gate drive circuit sequentially outputs a gate voltage in response to the gate control signal.

The pixel voltage and the gate voltage output by the drive chip 322 are supplied to the display panel 310 by way of the flexible film 330. Particularly, the pixel voltage from the data drive circuit is applied to the data lines DL1 to DLm, and the gate voltage from the gate drive circuit is sequentially applied to the gate lines GL1 to GLn.

According to another exemplary embodiment of the present invention, the date drive circuit may be embedded in the drive chip 322, and the gate drive circuit may be embedded in the display panel 310 through a thin film process, which is substantially identical to a process of forming the pixels 311. In this case, the gate drive circuit is aligned with the light blocking area BA of the display panel 310, thereby preventing an aperture ratio of the display panel 310 from decreasing.

FIG. 3 is a sectional view of the display panel for optical communication shown in FIG. 2, and FIG. 4 is a plan view of the first light receiving sensor shown in FIG. 3.

Referring to FIG. 3, the display panel 310 includes an array substrate 311, a color filter substrate 312 coupled with the array substrate 311, and a liquid crystal layer interposed between the array substrate 311 and the color filter substrate 312.

The array substrate 311 includes a first base substrate 311a, a thin film transistor Tr, and a pixel electrode PE. The first base substrate 311a is divided into the display area DA and the light blocking area BA adjacent to the display area DA. The thin film transistor Tr and the pixel electrode PE are provided on the first base substrate 311a in correspondence with the display area DA. In addition, the array substrate 311 further includes the first, second and third light receiving sensors 341, 342 and 343 shown in FIG. 1. In the present embodiment, the first to third light receiving sensors 341, 342 and 343 are provided in the light blocking area BA of the first base substrate 311a.

In detail, a gate electrode GE of the thin film transistor Tr is formed on the first base substrate 311a. Although not shown in FIG. 3, the gate lines GL1 to GLn (shown in FIG. 1) are formed substantially simultaneously with the gate electrode GE on the first base substrate 311a.

A gate insulating layer 311b covering the gate electrode GE is provided on the first base substrate 311a. Semiconductor layers a-si and ohmic contact layers n⁺a-si are sequentially formed on the gate insulating layer 311b. During the patterning process, the semiconductor layers a-si and the ohmic contact layers n⁺a-si are left only in the area where the gate electrode GE is formed and in the area where the first to third light receiving sensors 341, 342 and 343 are provided. The semiconductor layers a-si include amorphous silicon, and the ohmic contact layers n⁺a-si include n-doped amorphous silicon.

In the area where the gate electrode GE is formed, a source electrode SE and a drain electrode DE, which are spaced apart from each other by a predetermined distance, are provided on the ohmic contact layers n⁺a-si. In the area where the first light receiving sensor 341 is formed, first and second electrodes 341a and 341b, which are spaced apart from each other by a predetermined distance, are provided on the ohmic contact layers n⁺a-si. Similarly, in the area where the second light receiving sensor 342 is formed, third and fourth electrodes 342a and 342b, which are spaced apart from each other by a predetermined distance, are provided on the ohmic contact layers n⁺a-si. In addition, in the area where the third light receiving sensor 343 is formed, fifth and sixth electrodes 343a and 343b, which are spaced apart from each other by a predetermined distance, are provided on the ohmic contact layers n⁺a-si.

A drive voltage is applied to the first, third and fifth electrodes 341a, 342a and 343a. The semiconductor layers a-si of the first to third light receiving sensors 341, 342 and 343 detect the quantity of the red light Lr, the green light Lg, and blue light Lb, respectively, upon receiving the red light Lr, the green light Lg, and blue light Lb from the light generator 100. The second, fourth, and sixth electrodes 341b, 342b, 343b output a photo-current (not shown) corresponding to the quantity of light.

The controller 321 shown in FIG. 2 includes a converting circuit that receives the photo-current output from the first to third light receiving sensors 341, 342 and 343 and decodes the photo-current to convert the photo-current into first to third data D1, D2 and D3 that was encoded in the red light Lr, the green light Lg, and blue light Lb signals, respectively. This way, the display apparatus 300 shown in FIG. 2 displays characters and pictures on the display panel 310 in response to the first and second data D1 and D2, or controls an acoustic system (not shown) accommodated in the display apparatus 300 in response to the third data D3 such that the acoustic system can output music or sound.

In the present embodiment, the first to third light receiving sensors 341, 342 and 343 are structurally identical with each other. In this regard, the first light receiving sensor 341 will be described in detail with reference to FIG. 4, and detailed description of the second and third light receiving sensors 342 and 343 will be omitted in order to avoid redundancy.

Referring to FIG. 4, the first electrode 341a in the first light receiving sensor 341 includes a first base electrode 341a1 and a first branch electrode 341a2 branching from the first base electrode 341a1, and the second electrode 341b includes a second base electrode 341b1 and a second branch electrode 341b2 branching from the second base electrode 341b1. The first and second base electrodes 341a1 and 341b1 extend substantially parallel to each other, and the first and second branch electrodes 341a2 and 341b2 extend substantially parallel to each other. The first and second branch electrodes 341a2 and 341b2 are alternatingly disposed and spaced apart from adjacent electrodes by a first distance d1.

In one embodiment of the present invention, the first distance d1 may be about 10 μm. If the first distance d1 increases, the resistance of the first light receiving sensor 341 increases, thereby enhancing the sensitivity of the first light receiving sensor 341. Conversely, if the first distance d1 decreases, the resistance of the first light receiving sensor 341 decreases, thereby lowering the sensitivity of the first light receiving sensor 341. Therefore, the first distance d1 is preferably set to a distance (e.g., about 10 μm) selected by taking into account both the desired sensitivity and resistance levels of the first light receiving sensor 341.

The first light receiving sensor 341 further includes an input pad 341d receiving the drive voltage from the printed circuit board 320 (shown in FIG. 2) and an input line 341c electrically connecting the input pad 341d with the first electrode 341a. In addition, the first light receiving sensor 341 further includes an output line 341e extending from the second electrode 341b to output the photo-current, and an output pad 341f extending from the output line 341e and being electrically connected to the printed circuit board 320. In this manner, the first light receiving sensor 341 can be electrically connected to the printed circuit board 320 by way of the input pad 341d and the output pad 341f.

Referring again to FIG. 3, the thin film transistor Tr provided on the first base substrate 311a and the first to third light receiving sensors 341, 342 and 343 are covered with a protective layer 311c. A contact hole 311d is formed through the protective layer 311c and extend to the drain electrode DE of the thin film transistor Tr. A pixel electrode PE including a transparent conductive material is provided on the protective layer 311c. The pixel electrode PE is electrically connected to the drain electrode DE through the contact hole 311d.

Meanwhile, the color filter substrate 312 includes a second base substrate 312a, a color filter layer 312b, a black matrix 312c, and a common electrode 312d. The black matrix 312c is formed in the part of the display area DA (shown in FIG. 2) corresponding to where the thin film transistor Tr, the gate lines GL1 to GLn (shown in FIG. 2) and the data lines DL1 to DLm (shown in FIG. 2) are formed (hereinafter, referred to as a “non-effective display area”). The black matrix 312c is also formed over substantially the entire light blocking area BA except for an area where the first to third light receiving sensors 341, 342 and 343 are provided. Hence, the red light Lr, the green light Lg and the blue light Lb output from the light generator 100 can be provided to the first to third light receiving sensors 341, 342 and 343, respectively, without being blocked by the black matrix 312c.

The color filter layer 312b includes red, green and blue color filters R, G and B and is formed on the second base substrate 312a. Particularly, the region of the display area DA other than the non-effective display area is referred to as an effective display area, and the color filter layer 312b is provided in the effective display area. In addition, the red, green and blue color filters R, G and B are formed in the part of the light blocking area BA corresponding to the first to third light receiving sensors 341, 342 and 343, respectively. The red color filter R formed in the light blocking area BA allows only the red light Lr among the lights output from the light generator 100 to reach the first light receiving sensor 341. Similarly, the green color filter G formed in the light blocking area BA allows only the green light Lg among the lights output from the light generator 100 to reach the second light receiving sensor 342, and the blue color filter B formed in the light blocking area BA allows only the blue light Lb among the lights output from the light generator 100 to reach the third light receiving sensor 343.

In this manner, the light receiver 340 receiving the light from the light generator 100 is provided on the display panel 310 for optical communication through a thin film process that is used to form the display panel 310. Thus, the light receiver 340 can be readily embedded in the display panel 310 without an additional process. Hence, the manufacturing cost can be reduced in comparison to the structure in which a light receiving sensor is separately prepared in the form of a diode and mounted on the display apparatus 300.

Further, the first to third light receiving sensors 341, 342 and 343 are formed in the light blocking area BA of the display panel 310, so that the number of the first to third light receiving sensors 341, 342 and 343 can be increased without decreasing the aperture ratio of the display panel 310. Therefore, the present invention can improve the sensitivity and the light receiving rate of the light receiving sensors unlike the currently-available technique where the number of light receiving sensors that can be mounted on the display apparatus 300 is limited and prevention of decline in sensitivity and light receiving rate is difficult. The response speed of the optical communication can be increased due to improved receiving sensitivity and light receiving rate.

The common electrode 312d includes a transparent conductive material and is formed on the color filter layer 312b and black matrix 312c with a uniform thickness. The common electrode 312d is separated from the pixel electrode PE by a liquid crystal layer interposed therebetween. The common electrode 312d, the pixel electrode PE, and the liquid crystal layer form the liquid crystal capacitor Clc.

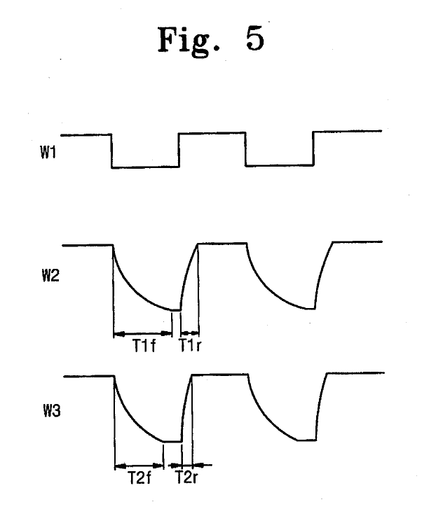

FIG. 5 shows a waveforms diagram illustrating the response speed of the second light receiving sensor as a function of the second electrical power. In FIG. 5, a first waveform W1 represents the phase of the second electrical power P2 (shown in FIG. 1) supplied to the light generator 100 (shown in FIG. 2), a second waveform W2 represents the phase of the second electrical power P2 of a conventional light receiving sensor including a photodiode, and a third waveform W3 represents the phase of the second electrical power P2 of the second light receiving sensor 342 (shown in FIG. 2) according to the present invention. The photodiode used in experiment is, for example, S9032 (product name) manufactured by Hamamatsu, Japan, and an interval between the two electrodes of the second light receiving sensor 342 is set to 10 μm.

Referring to FIG. 5, the first to third waveforms W1, W2 and W3 have the same phase. In the second waveform W2, a rising time T1r of the light receiver including the photodiode has been measured at about 207.2 μs, and a falling time T1f has been measured at about 687.4 μs. In the third waveform W3, a rising time T2r of the second light receiving sensor has been measured at about 100.0 μs, and a falling time T2f has been measured at about 581.9 μs. The rising time T2r of the second light receiving sensor 342 is faster than the rising time T1r of the photodiode by about 107.2 μs, and the falling time T2f of the second light receiving sensor 342 is faster than the falling time of the photodiode by about 105.5 μs. That is, the response speed of the second light receiving sensor 342 using amorphous silicon is improved compared to that of the related art employing the photodiode.

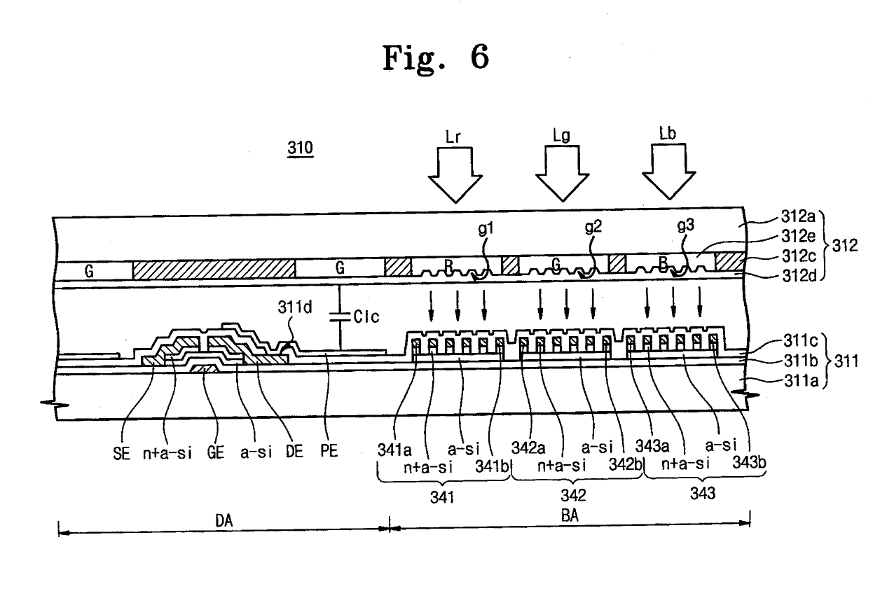

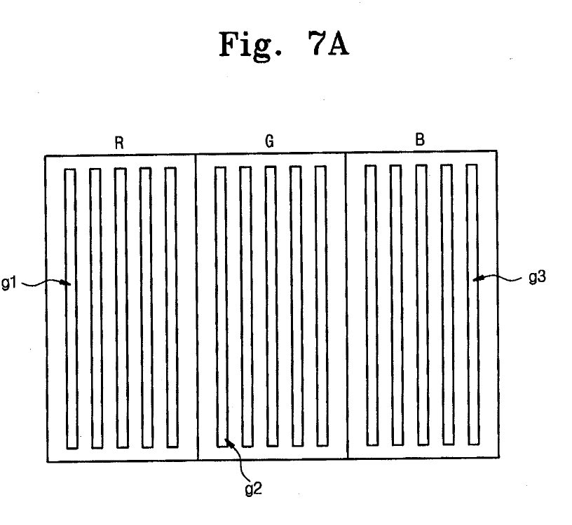

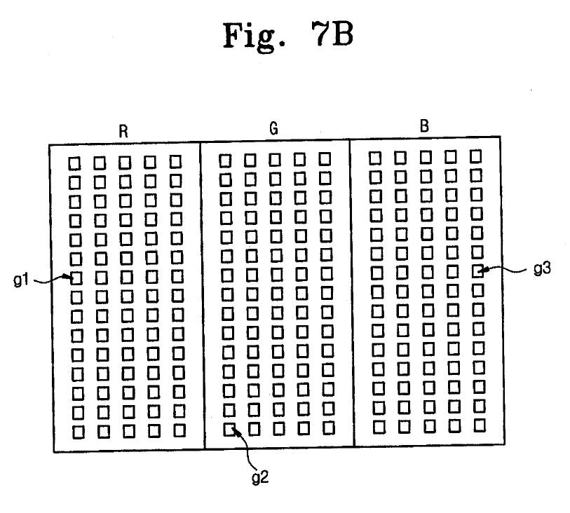

FIG. 6 is a sectional view of the display panel for optical communication according to another embodiment of the present invention, and FIG. 7A is a plan view of the color filter layer shown in FIG. 6. In FIG. 6, the same reference numerals denote the same elements in FIG. 3, and thus the detailed descriptions of the same elements will be omitted in order to avoid redundancy.

Referring to FIG. 6, the display panel 310 includes an array substrate 311, a color filter substrate 312, and a liquid crystal layer. The array substrate 311 is provided with first, second and third light receiving sensors 341, 342 and 343, which receive a red light Lr, a green light Lg and a blue light Lb encoded with information. Red, green and blue color filters R, G and B are formed in the parts of the color filter substrate 312 that correspond to the first to third light receiving sensors 341, 342 and 343 of the array filter substrate 311, respectively.

As shown in FIGS. 6 and 7A, in order to increase the transmittance of the red light Lr, the green light Lg and the blue light Lb, a plurality of first, second and third grooves g1, g2 and g3 are provided in the red, green and blue color filters R, G and B, respectively. The first to third grooves g1, g2 and g3 are formed corresponding to an area where amorphous silicon a-si is exposed in the first to third light receiving sensors 341, 342 and 343. In the present embodiment, the first to third grooves g1, g2 and g3 may be prepared in the form of a stripe pattern.

In this manner, since the first, second and third grooves g1, g2 and g3 are formed in the red, green and blue color filters R, G and B corresponding to the first, second and third light receiving sensors 341, 342 and 343, the thickness of the red, green and blue color filters R, G and B can be reduced in the area where the first to third light receiving sensors 341, 342 and 343 are formed. This way, the transmission of the red light Lr, the green light Lg and the blue light Lb being supplied to the first to third light receiving sensors 341, 342 and 343 can be increased, thereby improving the receiving sensitivity of the first to third light receiving sensors 341, 342 and 343.

FIG. 7B shows a plan view of a color filter layer according to another embodiment of the present invention.

Referring to FIG. 7B, the color filter layer according to another embodiment of the present invention includes the red, green and blue color filters R, G and B on which first, second and third grooves g1, g2 and g3 are formed, respectively. In an embodiment of the present invention, the first to third grooves g1, g2 and g3 are formed in regions of the color filter substrate 312 corresponding to areas in the array substrate 311 where the amorphous silicon a-si (shown in FIG. 6) in the first to third light receiving sensors 341, 342 and 343 is formed. Each of the grooves g1, g2, g3 is shown to be rectangular-shaped in the embodiment of FIG. 7B; however, this is not a limitation of the invention. For example, the first through third grooves g1, g2 and g3 may be prepared in the form of circular dots.

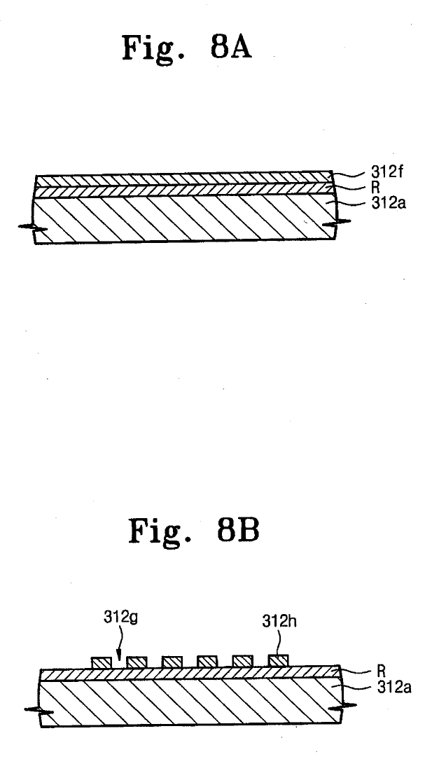

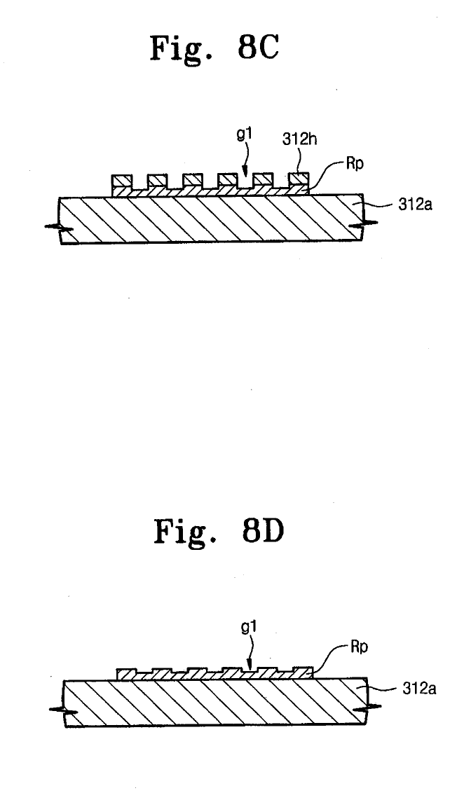

FIGS. 8A to 8D are sectional views illustrating a fabrication procedure for the color filter layer shown in FIG. 6 through a wet etching process. Although FIGS. 8A to 8D illustrate the fabrication procedure of the red color filter R, it should be noted that the green and blue color filters (see, FIG. 6) are manufactured using substantially the same procedure. In this regard, the detailed description of the fabrication procedure for the green and blue color filters will be omitted.

Referring to FIG. 8A, the second base substrate 312a has a red color filter R and a photoresist 312f deposited sequentially thereon.

When the photoresist 312f is patterned through a photolithography process, as shown in FIG. 8B, a photoresist pattern 312h is formed in the area where the red color filter R is formed later. Further, the photoresist pattern 312h is formed with a plurality of openings 312g in the form of a slit to expose the red color filter R formed thereunder.

Then, when the wet etching process is performed using an etchant in order to remove the red color filter R uncovered by the photoresist pattern 312h, as shown in FIG. 8C, a red color filter pattern Rp 312h is formed corresponding to an area where the photoresist pattern 312h is formed.

Here, the etchant flows into the red color filter pattern Rp through the openings 312g, so that the first grooves g1, which are recessed at the red color filter pattern Rp with a predetermined depth, are formed.

As shown in FIG. 8D, a stripping process is performed to strip the photoresist pattern 312h after the wet etching process is finished, thereby forming the red color filter pattern Rp having the first grooves g1 on the second base substrate 312a. In this manner, by forming the first grooves g1 on the red color filter pattern Rp, the thickness of the red color filter pattern Rp can be reduced, thereby improving the transmission of the red light Lr (shown FIG. 6). As a result, the receiving sensitivity of the first light receiving sensor 341 corresponding to the red color filter pattern Rp can be improved.

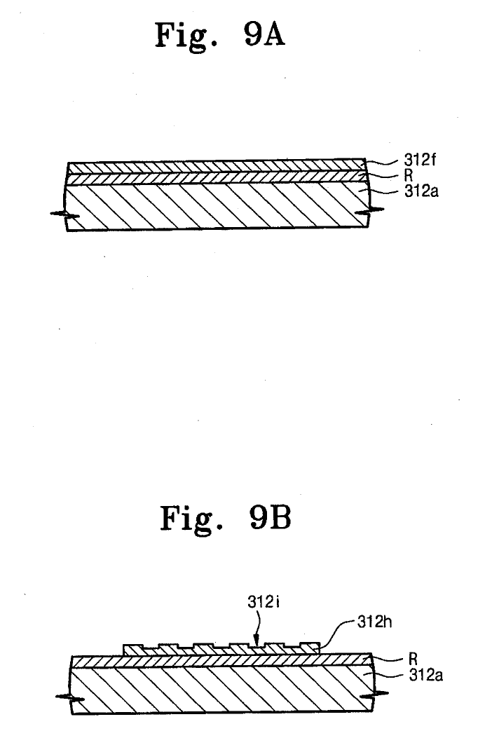

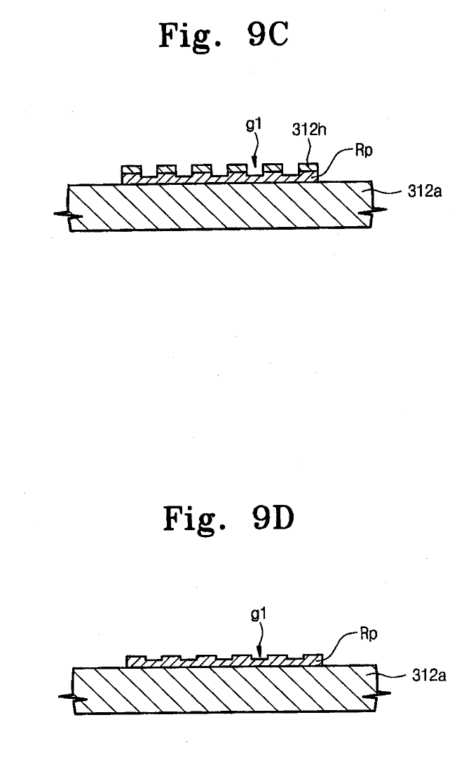

FIGS. 9A to 9D are sectional views illustrating a fabrication procedure for the color filter layer shown in FIG. 6 through a dry etching process.

Referring to FIG. 9A, the second base substrate 312a has a red color filter R and a photoresist 312f deposited sequentially thereon.

When the photoresist 312f is patterned through a photolithography process, as shown in FIG. 9B, a photoresist pattern 312h is formed. Further, a plurality of slit recesses 3121 having a predetermined depth are provided on the photoresist pattern 312h.

Then, when the dry etching process is performed so as to etch the red color filter R uncovered by the photoresist pattern 312h, as shown in FIG. 9C, a red color filter pattern Rp is provided on the area on which the photoresist pattern 312h is formed. During the etching process, the photoresist pattern 312h partially is removed, and the red color filter pattern Rp is also partially removed at the area where the slit recesses 3121 are formed. Thus, the first grooves g1 having a predetermined depth are formed on the red color filter pattern Rp.

As shown in FIG. 9D, a stripping process is performed in order to strip the photoresist pattern 312h after the dry etching process has been finished, so that the red color filter pattern Rp having the first grooves g1 is formed on the second base substrate 312a. In this manner, by forming the first grooves g1 on the red color filter pattern Rp, the thickness of the red color filter pattern Rp can be reduced, thereby improving the transmission of the red light Lr (shown FIG. 6). As a result, the receiving sensitivity of the first light receiving sensor 341 corresponding to the red color filter pattern Rp can be improved.

According to the display apparatus for optical communication as mentioned above, the light receiver detecting the light using amorphous silicon is embedded in the display panel. With this configuration, the receiving sensitivity of the display apparatus for optical communication can be improved and the response speed of the display apparatus is faster for optical communication.

Further, the light receiver detects the light using amorphous silicon included in the display panel, so that the light receiver can be embedded in the display panel without performing an additional manufacturing process.

In addition, the thickness of the color filter layer formed corresponding to the light receiver is reduced so that the transmission of the light supplied to the light receiver can be increased, thereby improving the receiving sensitivity of the light receiver.

Although exemplary embodiments of the present invention have been described, it is understood that the present invention should not be limited to these exemplary embodiments and various changes and modifications can be made by one ordinary skilled in the art within the spirit and scope of the present invention as hereinafter claimed.

What is claimed is:

1. A display apparatus for optical communication, the display apparatus comprising:
a display panel displaying an image;
a light receiver installed in the display panel to receive an optical signal and output a photo-current corresponding to the received optical signal; and
a controller decoding the photo-current output from the light receiver to obtain data encoded in the optical signal.

2. The display apparatus of claim 1, wherein the display panel comprises:
an array substrate having:
a display area that includes a plurality of pixels capable of displaying an image and
a light blocking area adjacent to the display area; and
a color filter substrate coupled with the array substrate and including:
a color filter layer having a plurality of color filters formed in a part of the color filter substrate that corresponds to the pixels of the array substrate, and
a black matrix formed in a part of the color filter substrate that corresponds to the light blocking area of the array substrate to block the light incident from a back side of the array substrate.

3. The display apparatus of claim 2, wherein the light receiver is formed on the blocking area of the array substrate through the same process as the pixels, and an opening is formed in a part of the black matrix that corresponds to an area of the array substrate having the light receiver to supply light to the light receiver.

4. The display apparatus of claim 3, wherein each of the pixels comprises a thin film transistor having amorphous silicon and a pixel electrode electrically connected to the thin film transistor, and
the light receiver comprises:
a semiconductor layer including amorphous silicon;
an ohmic contact layer including n-doped amorphous silicon formed on the semiconductor layer;
a first electrode provided on the ohmic contact layer and receiving a drive voltage; and
a second electrode provided on the ohmic contact layer and spaced apart from the first electrode by a predetermined distance to output the photo-current.

5. The display apparatus of claim 4, wherein the light receiver comprises:
an input line provided on the array substrate and electrically connected to the controller to apply the drive voltage to the first electrode; and
an output line provided on the array substrate and electrically connected between the second electrode and the controller to supply the photo-current to the controller.

6. The display apparatus of claim 1, wherein the light receiver comprises:
a first light receiving sensor receiving a red light;
a second light receiving sensor receiving a green light; and
a third light receiving sensor receiving a blue light.

7. The display apparatus of claim 6, wherein the display panel comprises a color filter layer having red, green and blue color filters, and
the red, green and blue color filters are provided corresponding to the first, second and third light receiving sensors, respectively.

8. The display apparatus of claim 7, wherein a plurality of first, second and third grooves, which are recessed with a predetermined depth, are formed on the red, green and blue color filters.

9. The display apparatus of claim 8, wherein each of the first to third light receiving sensors comprises:
a semiconductor layer including amorphous silicon;
an ohmic contact layer including n-doped amorphous silicon formed on the semiconductor layer;
a first electrode provided on the ohmic contact layer and receiving a drive voltage; and
a second electrode provided on the ohmic contact layer and spaced apart from the first electrode by a predetermined distance to output the photo-current;
wherein the first to third grooves are formed corresponding to the semiconductor layer arranged between the first electrode and second electrode.

10. A method of display apparatus for optical communication, the method comprising:
forming a plurality of pixels capable of displaying an image in a display area of a first base substrate and a light receiver receiving an optical signal and outputting a photo-current corresponding to the received optical signal in a light blocking area adjacent to the display area of the first base substrate through the same process as the pixels;
forming a color filter having a plurality of color filters corresponds to the pixels on a second base substrate opposite to the first base substrate;
forming a black matrix blocking a light incident from a back side of the first base substrate on the second base substrate corresponds to the light blocking area; and
forming an opening supplying light incident from a front side of the second base substrate to the light receiver in a part of the black matrix.
